(19) United States
(12) Patent Application Publication
(10) Pub. No.: US 2024/0375533 A1
(43) Pub. Date: Nov. 14, 2024

(54) LID OPENING AND CLOSING DEVICE

(71) Applicant: U-SHIN LTD., Nagano (JP)

(72) Inventor: Yuki TANAKA, Hiroshima (JP)

(21) Appl. No.: 18/691,630

(22) PCT Filed: Mar. 29, 2022
(86) PCT No.: PCT/JP2022/015667

§ 371 Date: Mar. 13, 2024

(30) Foreign Application Priority Data
Sep. 24, 2021 (JP) 2021-155991

(51) Int. Cl. B60L 53/16; E05B 83/34

(52) U.S. Cl. CPC B60L 53/16; E05B 83/34

(57) ABSTRACT

A lid opening and closing device includes a base having a bearing portion, a receiving portion attached to the base, a lid for closing an opening portion, an arm movable between retracted and advanced positions, a rotating body transmitting a drive force to a pivot portion to rotate, a cam rotating in conjunction with the rotating body, a transmission member movable by the cam, a lock member moving between lock and unlock positions by transmitting a rotational force of the rotating body via the cam and the transmission member, an engaging portion provided on the lid, and a differential mechanism starting rotation of the pivot portion with a delay with respect to start of rotation of the rotating body when the arm at the retracted position is moved to the advanced position.

### TECHNICAL FIELD

The present invention relates to a lid opening and closing device.

### BACKGROUND ART

Patent Documents 1 and 2 disclose a lid opening and closing device used for an electric automobile. The lid opening and closing device of Patent Document 1 includes a motor for automatically opening and closing a lid. The lid opening and closing device of Patent Document 2 includes a lock mechanism including an actuator for advancing and retracting a lock pin for locking the lid in a closed state.

### PRIOR ART DOCUMENTS

### Patent Documents

Patent Document 1: JP-A-2014-210473
Patent Document 2: JP-A-2011-240753

### SUMMARY OF THE INVENTION

### Problems to be Solved by the Invention

In the lid opening and closing device of Patent Document 1, since the lid in the closed state cannot be locked in an unreleasable manner, there is room for improvement in security. By applying the lock mechanism of Patent Document 2 to the lid opening and closing device of Patent Document 1, security can be improved. In this case, two drive sources for opening and closing the lid and for locking the lid are required, and thus the lid opening and closing device becomes large in size.

An object of the present invention is to suppress an increase in size of a lid opening and closing device and to realize automatic opening and closing and locking of a lid.

### Solutions to the Problems

The present invention provides a lid opening and closing device including: a base including a bearing portion and arranged inside an opening portion of a panel; a receiving portion attached to the base so as to be located in the opening portion; a lid that openably closes the opening portion; an arm including a pivot portion on one end side pivotally supported by the bearing portion and a distal end portion on the other end side connected to the lid, the arm being movable between a retracted position where the arm is retracted into the panel and the opening portion is closed by the lid, and an advanced position where the arm is protruded to an outside of the panel and the opening portion is opened; a rotating body that transmits a drive force received from a drive source to the pivot portion to move the arm between the retracted position and the advanced position; a cam that rotates in conjunction with the rotating body; a transmission member movable by the cam; a lock member that is attached to the transmission member moves between a lock position and an unlock position by transmitting a rotational force of the rotating body via the cam and the transmission member; an engaging portion provided on the lid, the engaging portion being engageable with the lock member having moved to the lock position when the arm is at the retracted position; and a differential mechanism that starts rotation of the pivot portion with a delay with respect to start of rotation of the rotating body when the arm at the retracted position is moved to the advanced position.

In the present aspect, since the rotating body that transmits the drive force of the drive source to the pivot portion of the arm to rotate is provided, the lid can be automatically opened and closed via the arm. The cam that rotates in conjunction with the rotating body, the transmission member movable by the cam, and the lock member attached to the transmission member are provided, and the lock member engages with the engaging portion of the lid when the arm rotates to the retracted position, so that the lid can be locked in an unreleasable manner. As described above, since the automatic opening and closing and the locking of the lid can be realized by one drive source, security can be improved while suppressing an increase in size and cost of the lid opening and closing device as compared with a case of mounting two drive sources.

### Effects of the Invention

In the present invention, an increase in size of the lid opening and closing device can be suppressed, and automatic opening and closing and locking of the lid can be realized.

### BRIEF DESCRIPTION OF THE DRAWINGS

FIG. 1 is a perspective view of a lid opening and closing device according to an embodiment of the present invention;

FIG. 2 is a plan view of the lid opening and closing device with a lid closed;

FIG. 3 is a cross-sectional view taken along line III-III of FIG. 1;

FIG. 4 is a cross-sectional view of the lid opening and closing device with the lid closed, similar to FIG. 3;

FIG. 5 is an exploded perspective view of the lid opening and closing device excluding a receiving portion as viewed from a vehicle interior side;

FIG. 6 is an enlarged cross-sectional view of a portion VI in FIG. 4;

FIG. 7 is a cross-sectional view taken along line VII-VII of FIG. 4;

FIG. 8 is an exploded perspective view of an arm and a drive mechanism;

FIG. 9 is a partial cross-sectional view of FIG. 2 taken along line IX-IX of FIG. 7;

FIG. 10 is a partial cross-sectional view of FIG. 2 taken along line X-X of FIG. 7;

FIG. 11A is a graph showing movements of the arm and a lock member during an opening operation of the lid;

FIG. 11B is a graph showing movements of the arm and the lock member at the time of a closing operation of the lid;

FIG. 12A is a cross-sectional view similar to FIG. 9 showing a state of a cam and a differential mechanism in a first process at the time of a lid opening operation;

FIG. 12B is a cross-sectional view similar to FIG. 6 in the state of FIG. 12A;

FIG. 13 is a cross-sectional view similar to FIG. 9 showing a state of the cam and the differential mechanism in a second process at the time of the lid opening operation;

FIG. 14 is a cross-sectional view similar to FIG. 9 showing the state of the cam and the differential mechanism in a lid opened state;

FIG. 15 is a perspective view showing a state of the cam and the differential mechanism in a first process at the time of a lid closing operation;

FIG. 16 is a perspective view showing a state of the cam and the differential mechanism in a second process at the time of the lid closing operation;

FIG. 17A is a perspective view showing a state of the cam and the differential mechanism in a third process at the time of the lid closing operation; and

FIG. 17B is a cross-sectional view similar to FIG. 6 in the state of FIG. 17A.

### DETAILED DESCRIPTION

Hereinafter, an embodiment of the present invention will be described with reference to the accompanying drawings.

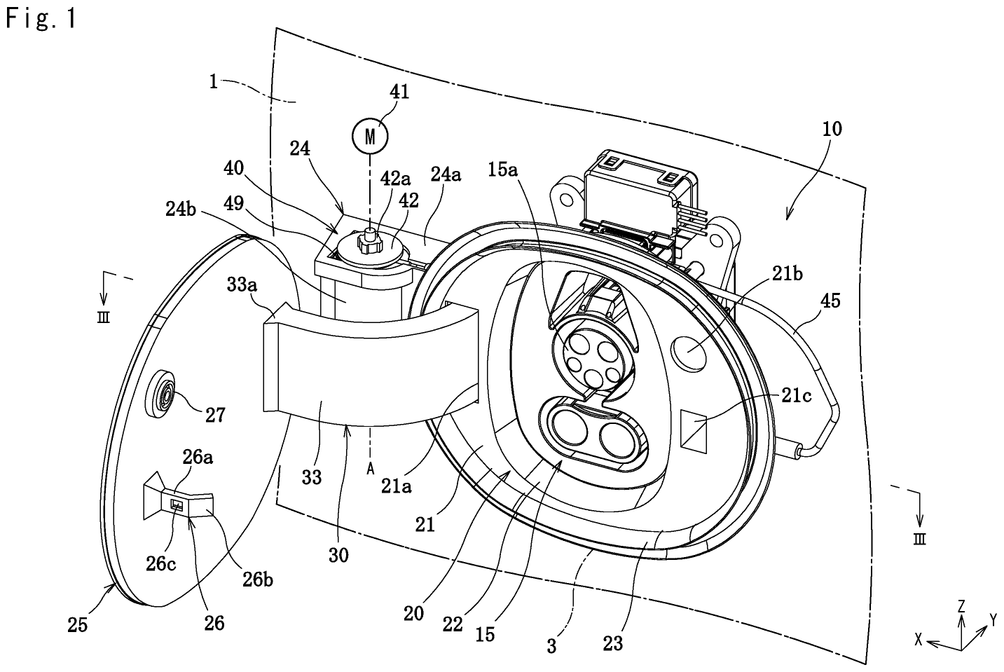

FIG. 1 shows a lid opening and closing device 10 according to an embodiment of the present invention. The lid opening and closing device 10 includes a power supply connector 15 to which a charging plug (not shown) is connected, and is attached to a side panel (panel) 1 of the automobile. The power supply connector 15 is a receiving portion for supplying electricity. However, the receiving portion may be configured to be replenished with any of liquid fuel such as gasoline and light oil, and gaseous fuel such as hydrogen and LP gas instead of the power supply connector 15.

An X direction described in each drawing cited in the following description is an automobile length direction of the automobile, a Y direction is an automobile width direction of the automobile, and a Z direction is an automobile height direction of the automobile. In each drawing, the direction indicated by the arrow in the X direction is the front side, and the direction opposite to the arrow is the rear side. The direction indicated by the arrow in the Y direction is a vehicle interior side (inner side), and the direction opposite to the arrow is a vehicle exterior side (outer side). The direction indicated by the arrow in the Z direction is the upper side, and the direction opposite to the arrow is the lower side.

Referring to FIGS. 1 to 4, the side panel 1 is provided with a concave portion 2 recessed inward in the vehicle width direction Y. An outer end of the concave portion 2 in the vehicle width direction Y is an opening portion 3. An attachment port 4 for attaching the lid opening and closing device 10 is provided at the bottom of the concave portion 2. The shapes of the opening portion 3 and the attachment port 4 as viewed in the vehicle width direction Y are substantially elliptical in the present embodiment, but can be changed as necessary.

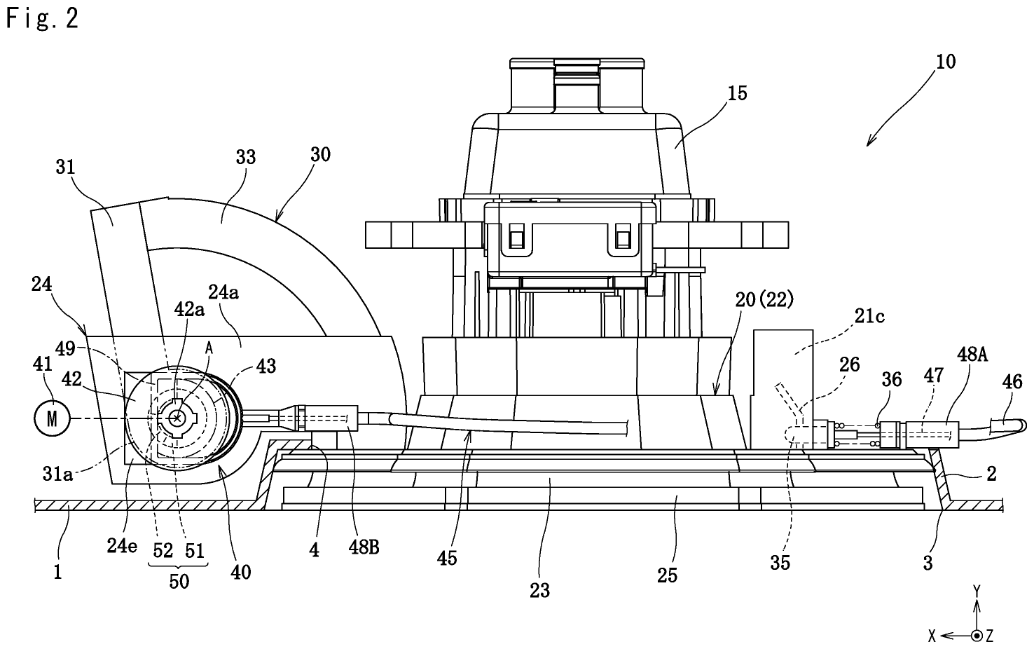

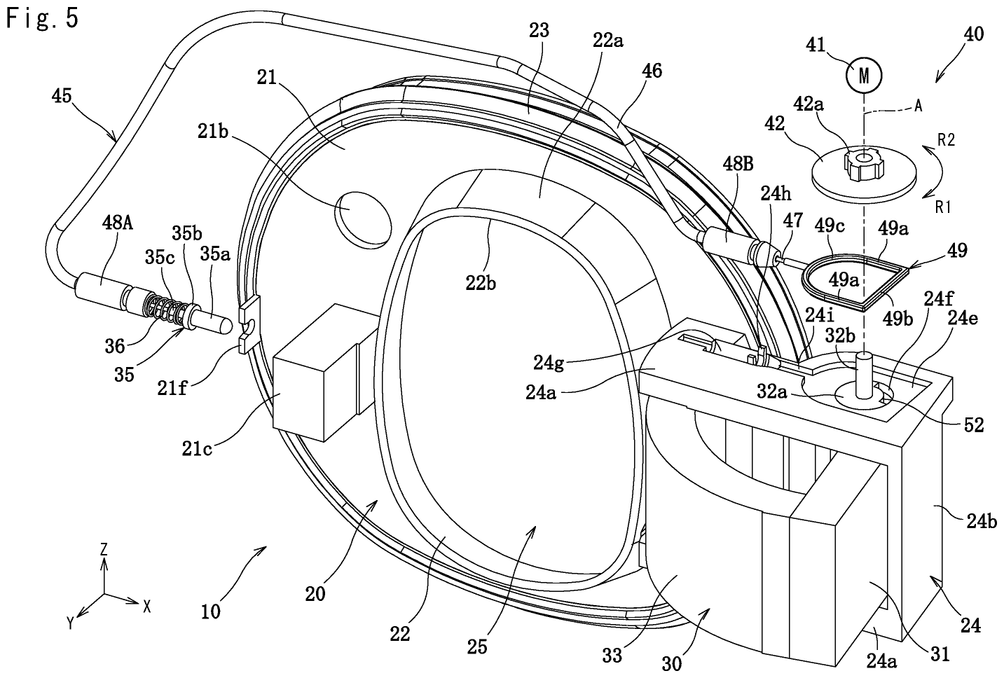

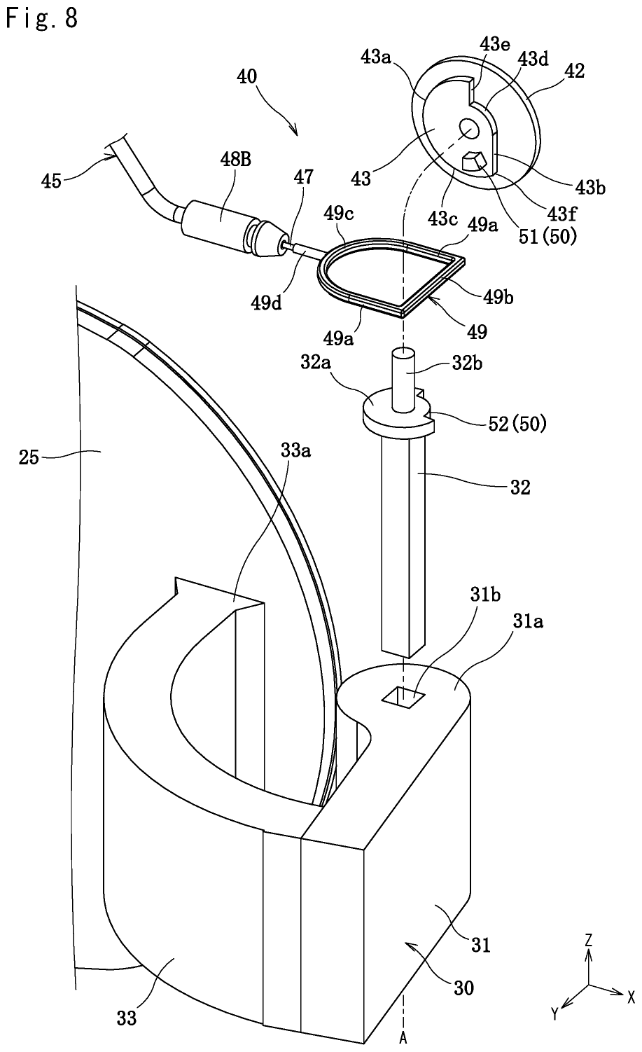

Subsequently, referring to FIGS. 1 to 4, the lid opening and closing device 10 includes a base 20 attached to the side panel 1, a lid 25 for closing the opening portion 3, and an arm 30 having one end side pivotally supported by the base 20 and the other end side to which the lid 25 is attached. Referring to FIGS. 2 and 5, the lid opening and closing device 10 of the present embodiment includes the lock member 35 that locks the lid 25 at the closed position, and the drive mechanism 40 that moves the arm 30 and the lock member 35. Furthermore, referring to FIGS. 2 and 8, the differential mechanism 50 for securing a time difference between the start of rotation of the arm 30 and the start of movement of the lock member 35 is provided at a coupling portion between the drive mechanism 40 and the arm 30.

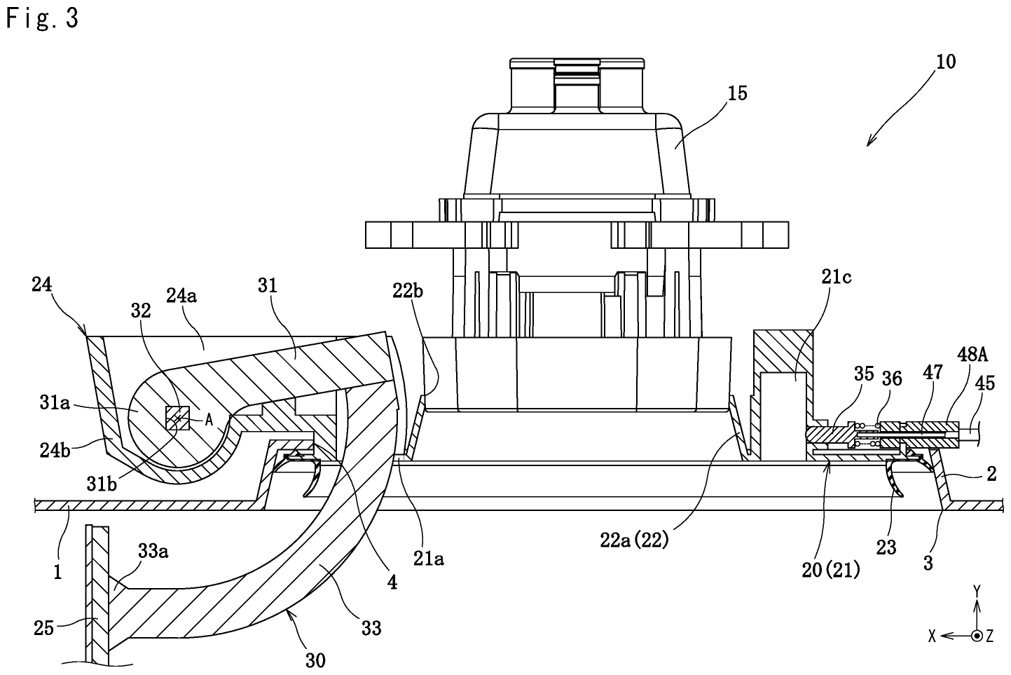

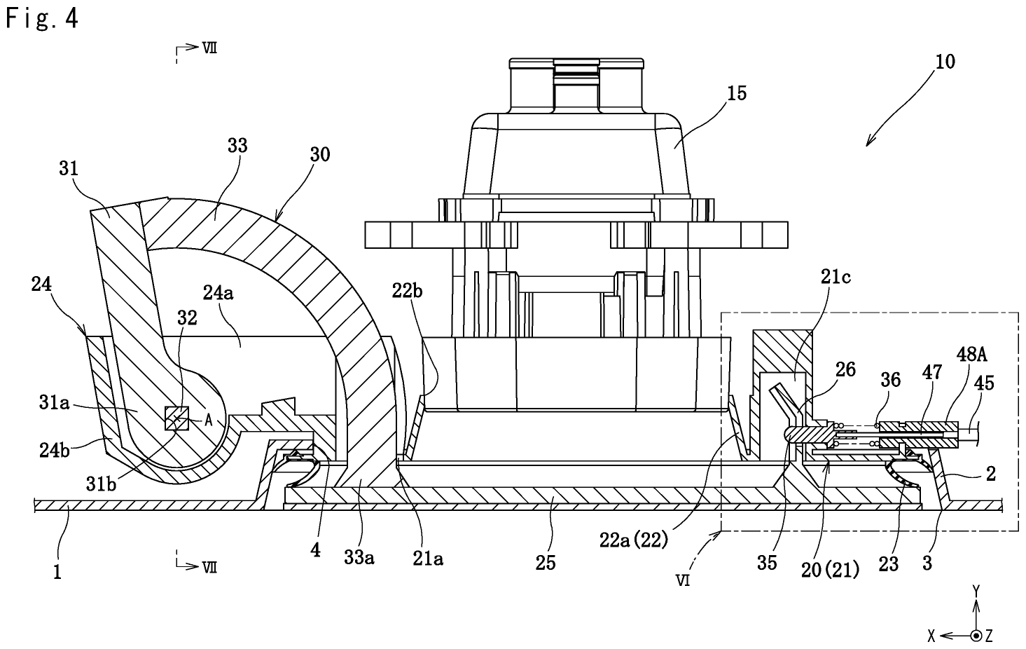

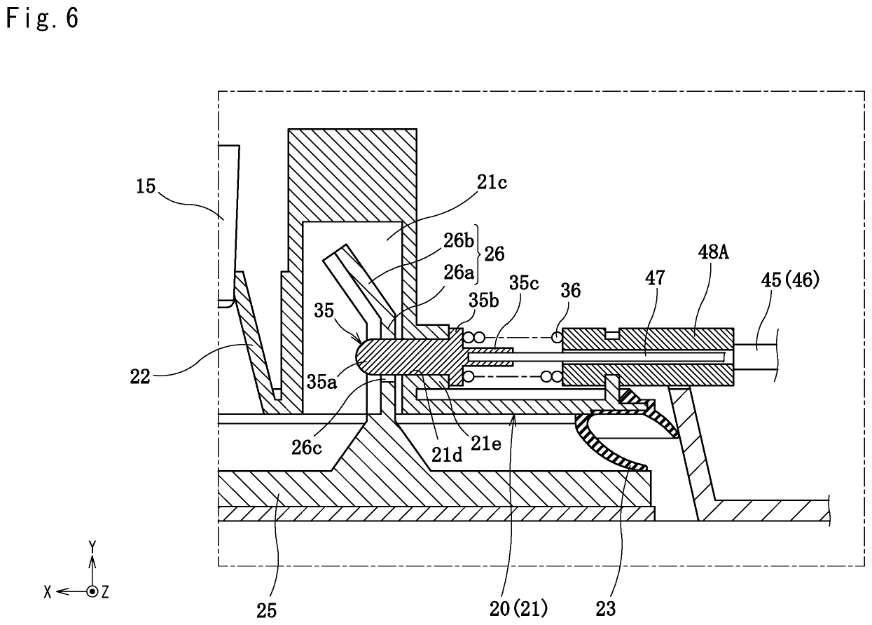

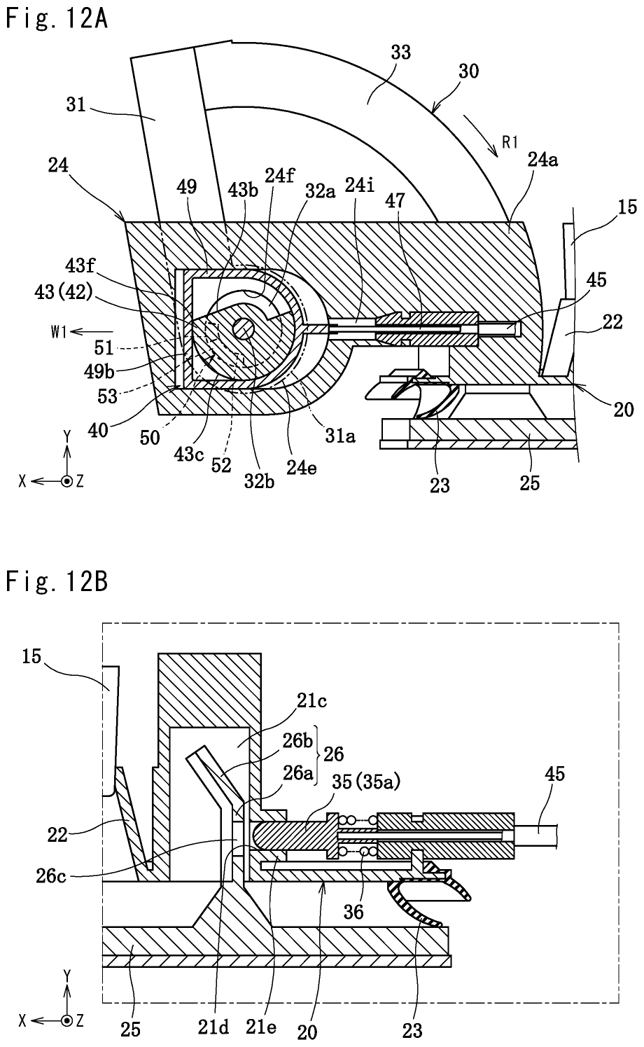

The arm 30 is rotated by the drive mechanism 40 between an advanced position protruding to the outside of the side panel 1 as shown in FIG. 3 and a retracted position retracted into the side panel 1 as shown in FIG. 4. The lid 25 takes a posture (open position) in which the opening portion 3 is opened when the arm 30 is rotated to the advanced position as shown in FIG. 3, and takes a posture (closed position) in which the opening portion 3 is closed when the arm 30 is rotated to the retracted position as shown in FIG. 4. In addition, the lock member 35 linearly moves (moves) between a lock position shown in FIG. 6 and an unlock position shown in FIG. 12B by the drive mechanism 40. The differential mechanism 50 starts the rotation of the arm 30 with a delay with respect to the start of the movement of the lock member 35. In the following description, the rotation of the lid 25 accompanying the rotation of the arm 30 by the drive mechanism 40 may be simply referred to as the rotation of the lid 25 by the drive mechanism 40.

Hereinafter, the base 20, the lid 25, the arm 30, the lock member 35, the drive mechanism 40, and the differential mechanism 50 will be specifically described.

Referring to FIGS. 3 to 5, the base 20 is arranged inside the opening portion 3 of the side panel 2, and includes a base body 21 that closes the attachment port 4 and a bearing portion 24 that pivotally supports the arm 30.

The base body 21 is provided with an attachment portion 22 for attaching the power supply connector 15, and a seal member 23 for sealing between the lid 25 at the closed position and the base body 21 is attached.

Referring to FIG. 4, the attachment portion 22 includes a concave portion 22a recessed inward in the vehicle width direction Y, and an attachment port 22b is formed at the bottom of the concave portion 22a. A power supply connector 15 is attached to the attachment port 22b from the inside in the vehicle width direction Y. Thus, as shown in FIG. 1, a connecting portion 15a of the power supply connector 15 is located in the opening portion 3, and is exposed to the outside of the vehicle through the opening portion 3 when the lid 25 is released.

Referring to FIGS. 3 and 4, the seal member 23 has a ring shape, is attached to the outer side of the base body 21 in the vehicle width direction Y along the outer peripheral edge of the base body 21, and protrudes from the bottom side of the concave portion 2 toward the opening portion 3. The seal member 23 is brought into pressure contact with the lid 25 at the closed position shown in FIG. 4, and seals a space between the base body 21 and the lid 25 in a watertight manner. The seal member 23 is not brought into pressure contact with the lid 25 at the open position shown in FIG. 3.

Referring to FIGS. 1 and 5, the base body 21 is provided with an insertion through hole 21a, a window through hole 21b, and a concave portion 21c so as to be located in the opening portion 3.

The insertion through hole 21a is a quadrangular hole having a long dimension in the vehicle height direction Z, and is provided so as to be located on the front side of the attachment portion 22 in the vehicle length direction X and in the bearing portion 24. The arm 30 is inserted through the insertion through hole 21a so as to be movable forward and backward.

The window through hole 21b is formed of a circular hole and is provided on the rear side in the vehicle length direction X of the attachment portion 22. The window through hole 21b exposes an operation unit of a switch (not shown) when the lid 25 is released.

The concave portion 21c is a quadrangular recess extending inward in the vehicle width direction Y, and is provided below the window through hole 21b. Referring to FIGS. 6 and 12B, a lock piece 26 described later is inserted into the concave portion 21c so as to be movable forward and backward. An insertion through hole 21d through which the lock member 35 is inserted so as to be movable forward and backward is provided in a wall defining the concave portion 21c. The insertion through hole 21d is provided in a wall located on the rear side in the vehicle length direction X. A cylindrical holding portion 21e that holds the lock member 35 is provided around the insertion through hole 21d. Referring to FIG. 5, an attachment piece 21f to which one end of a cable 45 (described later) included in the drive mechanism 40 is attached is provided on the rear side of the concave portion 21c in the vehicle length direction in the base body 21.

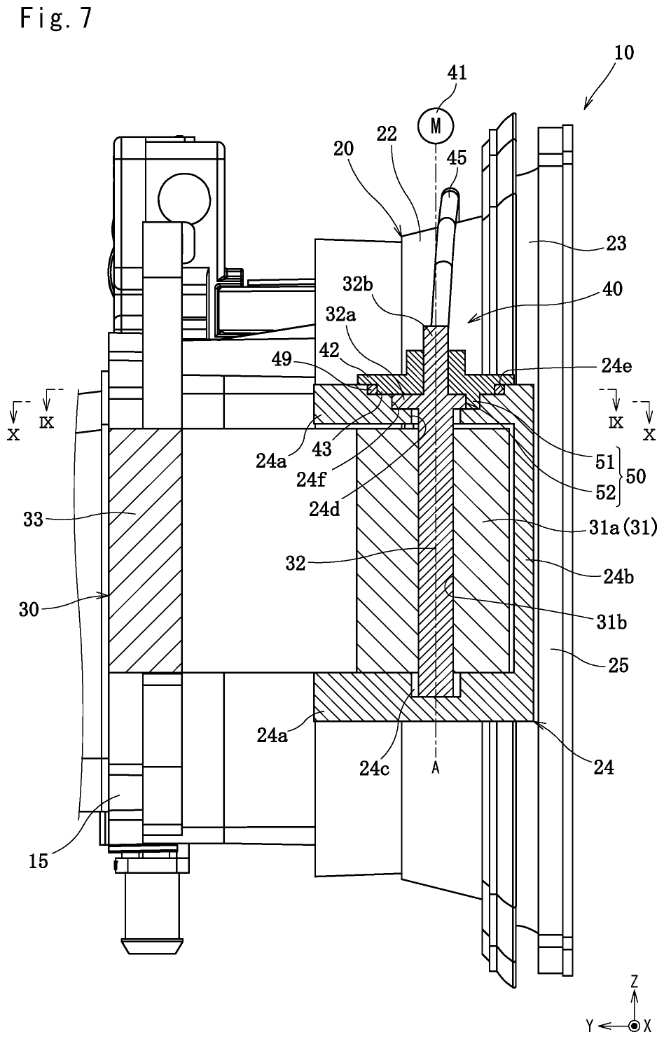

Referring to FIGS. 5 and 7, the bearing portion 24 has an integral structure with the base body 21, is adjacent to the front side of the attachment portion 22 in the vehicle length direction X, and protrudes outward from the base body 21. The bearing portion 24 includes a pair of end plates 24a and a coupling plate 24b coupling the end plates 24a. The pair of end plates 24a are provided at intervals in the vehicle height direction Z so as to be located above and below the insertion through hole 21a, and both extend along the XY plane. The coupling plate 24b is continuous with the front end in the vehicle length direction X and the outer end in the vehicle width direction Y of each of the pair of end plates 24a, and opens the other end portion of the end plate 24a.

The lower end plate 24a is provided with a shaft hole 24c, and the upper end plate 24a is provided with a shaft through hole 24d at a position facing the shaft hole 24c. The shaft hole 24c is a circular recess, and the shaft through hole 24d is a circular through hole having the same diameter as the shaft hole 24c. A center line in the vehicle height direction Z passing through the shaft hole 24c and the shaft through hole 24d is the rotation axis A.

The upper end plate 24a is further provided with a guide concave portion 24e, a holding concave portion 24f, and an attachment concave portion 24g. All of them are provided so as to be recessed downward from the upper surface side of the upper end plate 24a.

Referring to FIGS. 5, 7, and 9, the guide concave portion 24e is provided in a region including the shaft through hole 24d, and holds a cam follower 49 (described later) included in the drive mechanism 40 so as to be movable in the vehicle length direction X. When viewed in the vehicle height direction Z, the guide concave portion 24e has a semi-elliptical shape including a first portion 24e1 having a quadrangular shape and a second portion 24e2 having a semicircular shape. The second portion 24e2 is continuous with the rear side of the first portion 24e1 in the vehicle length direction X.

Referring to FIGS. 5, 7, and 10, the holding concave portion 24f is provided at the bottom of the guide concave portion 24e so as to be adjacent to the upper side of the shaft through hole 24d. The holding concave portion 24f has a circular shape having a larger diameter than the shaft through hole 24d, and spatially communicates with each of the lower shaft through hole 24d and the upper guide concave portion 24e.

Referring to FIG. 5, the attachment concave portion 24g has a semicircular cross section, and one end of the cable 45 of the drive mechanism 40 is attached thereto. The attachment concave portion 24g is provided with a holding piece 24h having a C-shaped cross section for holding the cable 45. A communication groove 24i that spatially communicates the attachment concave portion 24g and the guide concave portion 24e is provided therebetween.

Referring to FIGS. 1, 3, and 4, the lid 25 has a plate shape smaller than the opening portion 3 and larger than the seal member 23, and closes the opening portion 3 so as to be openable. The lid 25 is rotatable with respect to the base 20 by being coupled to the arm 30 pivotally supported by the bearing portion 24.

Referring to FIGS. 1 and 6, the lid 25 is provided with a lock piece (engaging portion) 26 to be inserted into the concave portion 21c of the base 20 when the lid 25 is rotated to the closed position shown in FIG. 4. The lock piece 26 includes a lock piece body 26a and an inclined portion 26b.

The lock piece body 26a protrudes in the orthogonal direction toward the inside in the vehicle width direction Y from the lid 25 in the closed state of the lid 25. A quadrangular lock through hole 26c with which the lock member 35 engages is formed in the lock piece body 26a.

The inclined portion 26b is continuous with the inner end of the lock piece body 26a in the vehicle width direction Y, and is inclined in a direction away from the lock member 35 from the outside to the inside in the vehicle width direction Y.

Referring to FIG. 1, the lid 25 includes a pressing portion 27 facing the window through hole 21b when rotated to the closed position. The pressing portion 27 protrudes from the lid 25 toward the inside in the vehicle width direction Y in the orthogonal direction. When the lid 25 at the closed position is further pressed inward in the vehicle width direction Y, the switch arranged in the window through hole 21b can be operated by the pressing portion 27.

Referring to FIGS. 1, 3, and 4, the arm 30 is arranged to straddle from the inside to the outside of the base 20 in the vehicle width direction Y through the insertion through hole 21a. The arm 30 includes a plate-shaped first arm portion 31 pivotally supported by the bearing portion 24 and an arc-shaped second arm portion 33 connected to the lid 25.

A pivot portion 31a pivotally supported by the bearing portion 24 is provided at a proximal end (one end side of the arm 30) of the first arm portion 31. That is, the first arm portion 31 protrudes outward from the pivot portion 31a. Referring to FIGS. 7 and 8, the pivot portion 31a includes an attachment through hole 31b having a square (non-circular) cross section in which the shaft member 32 is attached. The pivot portion 31a is arranged between the pair of end plates 24a of the bearing portion 24 and is rotatable about the rotation axis A via the shaft member 32.

With continued reference to FIGS. 7 and 8, the shaft member 32 is a rod body having a square cross section passing through the attachment through hole 31b of the first arm portion 31, and rotates integrally with the pivot portion 31a. That is, the shaft member 32 cannot rotate relative to the pivot portion 31a. The shaft member 32 penetrates the shaft through hole 24d from the upper side of the bearing portion 24, has a distal end arranged in the shaft hole 24c, and is rotatably supported by the inner peripheral wall of each of the shaft hole 24c and the shaft through hole 24d.

Referring to FIGS. 5 and 7, the shaft member 32 includes a flange portion 32a rotatably held in the holding concave portion 24f and a shaft portion 32b protruding upward from the flange portion 32a. The thickness of the flange portion 32a is substantially the same as the depth of the holding concave portion 24f in the vehicle height direction Z. The shaft portion 32b has an axis coinciding with the rotation axis A, and protrudes upward from the guide concave portion 24e in a state of being attached to the bearing portion 24.

Referring to FIGS. 1, 3, and 4, the second arm portion 33 is mechanically connected to a distal end of the first arm portion 31 on a side opposite to the pivot portion 31a. The second arm portion 33 has an arc shape centered on the rotation axis A. A connecting portion (distal end portion) 33a mechanically connected to the lid 25 is provided at the distal end of the second arm portion 33 (the other end side of the arm 30).

Referring to FIGS. 2, 5, and 6, the lock member 35 is arranged in the insertion through hole 21d of the base 20 so as to be movable forward and backward. The lock member 35 is attached to a wire 47 of the cable 45, a rotational force of the rotating body 42 described later is transmitted via a cam 43 and the wire 47, and is linearly moved to a lock position shown in FIG. 6 and an unlock position shown in FIG. 12B. The lock member 35 is elastically biased toward the lock position side (the front side in the vehicle length direction X, which is the lock piece 26 side) by a spring 36 having one end supported by the cable 45. Specifically, the lock member 35 includes a lock portion 35a and a flange portion 35b.

The lock portion 35a has a rod shape having a diameter smaller than that of the insertion through hole 21d, and has a hemispherical chamfered distal end. The lock portion 35a protrudes into the concave portion 21c when at the lock position, and engages with the lock through hole 26c when the lock piece 26 is in the concave portion 21c to prevent (lock) movement of the lock piece 26 outward in the vehicle width direction Y. The lock portion 35a is retracted into the holding portion 21e when at the unlock position, the engagement with the lock through hole 26c of the lock piece 26 is released, and the movement of the lock piece 26 toward the outside in the vehicle width direction Y is allowed (unlocked).

The flange portion 35b has a disk shape having a diameter larger than the diameter of each of the insertion through hole 21d and the spring 36. Referring to FIGS. 6 and 12B, the flange portion 35b is located outside the holding portion 21e at either the lock position or the unlock position. When the lock member 35 moves to the lock position, the flange portion 35b abuts on the holding portion 21e and restricts further movement of the lock member 35. The flange portion 35b is provided with a cylindrical attachment portion 35c to be attached to the wire 47.

Referring to FIGS. 2 and 5, the drive mechanism 40 includes one motor 41, a rotating body 42, a cam 43, and a cable 45, and is arranged on an upper portion of the base 20. Among them, the cable 45 includes a cam follower 49 that follows the rotation of the cam 43.

The motor 41 is a drive source capable of forward rotation and backward rotation, and performs both opening and closing of the lid 25 and movement of the lock member 35 between the lock position and the unlock position. The motor 41 rotates forward or backward in accordance with a command from an electronic control unit (ECU) electrically connected via a drive circuit. By the forward rotation, the motor 41 actuates the arm 30 at the retracted position to the advanced position, and actuates the lock member 35 at the lock position to the unlock position. By the backward rotation, the motor 41 actuates the arm 30 at the advanced position to the retracted position, and actuates the lock member 35 at the unlock position to the lock position.

The rotating body 42 has a disk shape and is arranged on the bearing portion 24 side of the base 20. The rotating body 42 transmits the drive force received from the motor 41 to the pivot portion 31a to rotate the arm 30, and transmits the drive force to the lock member 35 to move the lock member 35. Specifically, the rotating body 42 includes an attachment portion 42a attached to the motor 41, and is directly rotated by the motor 41. Referring to FIGS. 5 and 10, the rotating body 42 rotates in the direction indicated by R1 when the motor 41 rotates forward to open the lid 25, and rotates in the direction indicated by R2 when the motor 41 rotates backward to close the lid 25.

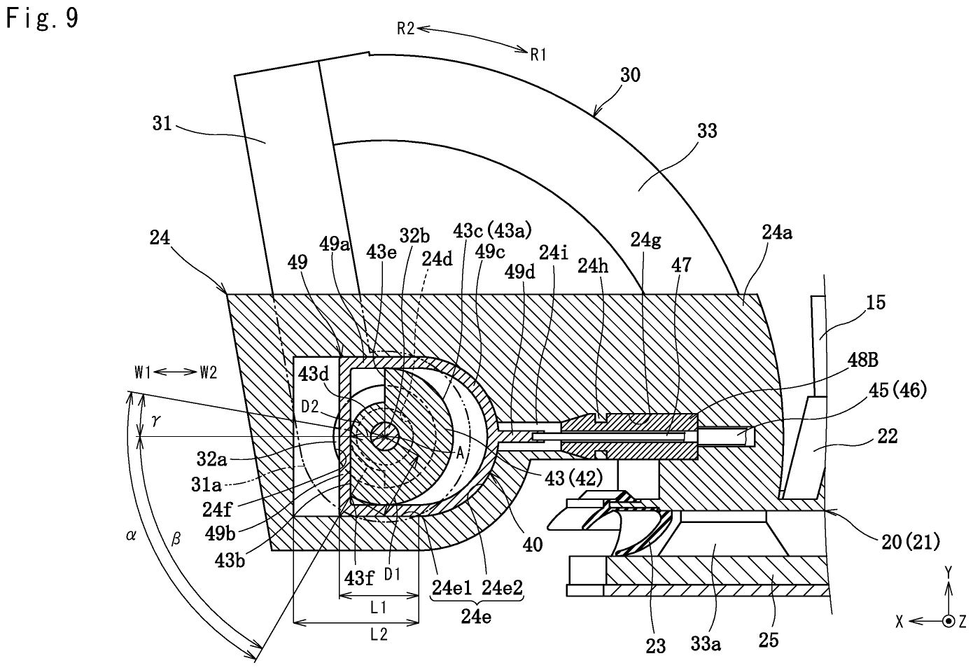

Referring to FIGS. 7 and 8, the rotating body 42 is arranged on the guide concave portion 24e of the base 20 so as to be coaxial with the pivot portion 31a of the arm 30. That is, the rotation axis of the rotating body 42, the rotation axis A of the pivot portion 31a, and the axis of the bearing portion 24 all coincide with each other. The rotating body 42 is coupled to the pivot portion 31a via a differential mechanism 50. As a result, as shown in FIGS. 9 and 10, the pivot portion 31a (arm 30) rotates in the same directions R1 and R2 as the rotating body 42.

Referring to FIGS. 7 and 8, the cam 43 has an integral structure with the rotating body 42, and rotates in the directions R1 and R2 in conjunction with the rotating body 42. Specifically, the cam 43 protrudes from the lower surface of the rotating body 42 facing the pivot portion 31a, and is arranged in the guide concave portion 24e of the base 20 so as to be adjacent to the pivot portion 31a. The protruding amount of the cam 43 in the vehicle height direction Z is the same as the depth of the guide concave portion 24e.

Referring to FIGS. 8 and 9, the cam 43 includes a rotation axis coinciding with the rotation axis A and a non-circular outer peripheral portion 43a. That is, the cam 43 and the pivot portion 31a have the same rotation axis A. The outer peripheral portion 43a includes a first straight portion 43b, a first arcuate portion 43c, a second arcuate portion 43d, and a second straight portion 43e.

The first straight portion 43b transmits the rotational force of the rotating body 42 to the lock member 35 via the cable 45 to move the lock member 35 to the lock position and the unlock position. Specifically, the first straight portion 43b linearly extends between a position at a distance D1 from the rotation axis A and a position at a distance D2 from the rotation axis A. The angular position around the rotation axis A is different between one end on the distance D1 side and the other end on the distance D2 side. The distance D2 is shorter than the distance D1, and the dimensional difference (D1−D2) between the distances D1 and D2 corresponds to the movement stroke of the lock member 35. That is, an angular range β from one end to the other end of the first straight portion 43b corresponds to the rotational angle of the cam 43 for moving the lock member 35 to the lock position and the unlock position.

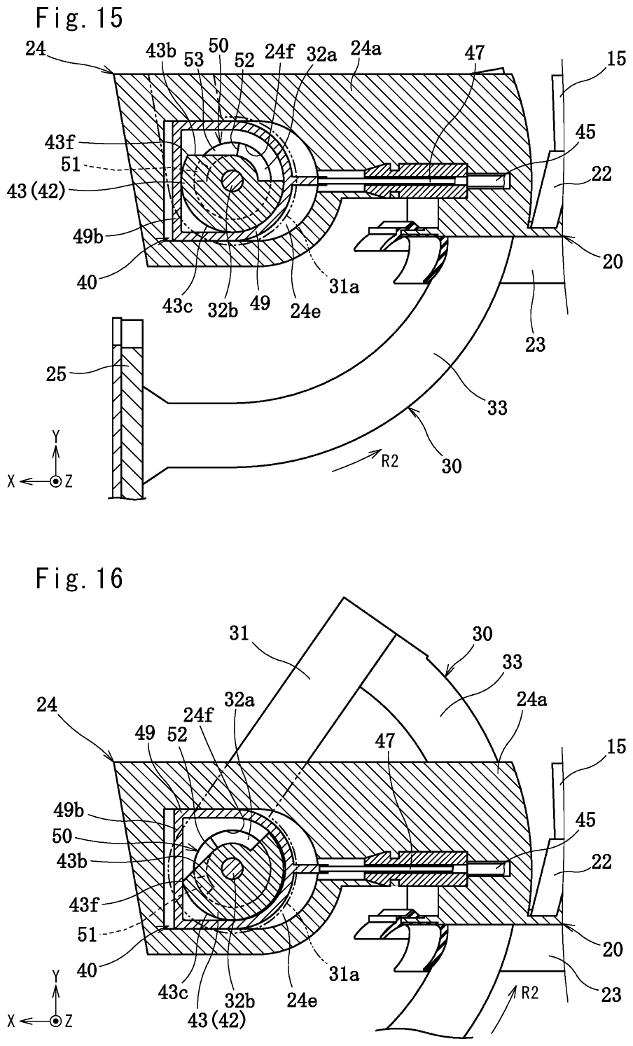

One end of the first straight portion 43b on the distance D1 side constitutes a pressing portion 43f that presses the cam follower 49. When the cam 43 rotates in the direction R1 at the time of the lid opening operation, the pressing portion 43f moves to the front side in the vehicle length direction X, which is the left side in FIG. 9, and presses and moves the cam follower 49 in the same direction. When the cam 43 rotates in the direction R2 at the time of the lid closing operation, the pressing portion 43f moves to the rear side in the vehicle length direction X, which is the right side in FIG. 15, and allows the movement of the cam follower 49 in the same direction.

The first arcuate portion 43c holds the lock member 35 at the unlock position via the cable 45. The first arcuate portion 43c has an arc shape centered on the rotation axis A, and is continuous with the pressing portion 43f of the first straight portion 43b. The radius of the first arcuate portion 43c is the same dimension as the distance D1 of the pressing portion 43f. The angular range for forming the first arcuate portion 43c is preferably 180 degrees or more, and is 210 degrees in the present embodiment.

The second arcuate portion 43d holds the lock member 35 at the lock position via the cable 45. The second arcuate portion 43d has an arc shape centered on the rotation axis A, and is continuous with an end portion of the first straight portion 43b on the distance D2 side. The radius of the second arcuate portion 43d is the same dimension as the distance D2.

The second straight portion 43e is not involved in the movement of the lock member 35 via the cable 45. The second straight portion 43e is continuous with an end portion of the first arcuate portion 43c not continuous with the first straight portion 43b and an end portion of the second arcuate portion 43d not continuous with the first straight portion 43b, and extends in the radial direction of the first arcuate portion 43c. That is, the angular position around the rotation axis A is the same at the inner end and the outer end of the second straight portion 43e.

Referring to FIGS. 2 and 5, the cable 45 is a transmission member that transmits the rotational force of the cam 43 to the lock member 35 to move, and includes a tube 46 having flexibility, a wire 47 movable forward and backward in the tube 46, and a cam follower 49. The lock member 35 is attached to an end portion of the wire 47 on the rear side in the vehicle length direction X opposite to the bearing portion 24, and the cam follower 49 is attached to an end portion on the front side in the vehicle length direction X on the bearing portion 24 side.

A cable end 48A is attached to an end portion of the tube 46 on the lock member 35 side, and a cable end 48B is attached to an end portion of the tube 46 on the cam follower 49 side. The cable end 48A is attached to the attachment piece 21f of the base 20, and the cable end 48B is attached to the attachment concave portion 24g of the base 20. Referring to FIG. 6, a spring 36 is arranged in a compressed state between the cable end 48A and the lock member 35.

Referring to FIGS. 5, 8, and 9, the cam follower 49 has an annular shape surrounding the outer peripheral portion 43a of the cam 43, and is movably arranged in the guide concave portion 24e of base 20. The rotation of the cam 43 allows the cam follower 49 to move between a first operating position where the cam follower 49 moves to the front side (direction W1) in the vehicle length direction X in the guide concave portion 24e as shown in FIG. 12A and a second operating position where the cam follower 49 moves to the rear side (direction W2) in the vehicle length direction X in the guide concave portion 24e as shown in FIG. 9.

The thickness of the cam follower 49 in the vehicle height direction Z is substantially equal to the protruding amount of the cam 43 and the depth of the guide concave portion 24e. The cam follower 49 has a semi-elliptical shape as viewed in the vehicle height direction Z, and includes a pair of side portions 49a, a press receiving portion 49b, an arcuate portion 49c, and an attachment portion 49d.

Each of the pair of side portions 49a extends linearly in the vehicle length direction X and is arranged adjacent to a pair of side walls extending in the vehicle length direction X in the first portion 24e1 of the guide concave portion 24e. A length L1 of the side portion 49a in the vehicle length direction X is shorter than the length L2 of the first portion 24e1 of the guide concave portion 24e in the vehicle length direction X. A dimensional difference (L2−L1) between the length L1 of the side portion 49a and the length L2 of the first portion 24e1 is larger than a dimensional difference (D1−D2) between the distances D1 and D2 of the first straight portion 43b, that is, a movement stroke of the lock member 35 between the lock position and the unlock position.

The press receiving portion 49b is continuous with each of the front ends of the pair of side portions 49a in the vehicle length direction X and linearly extends in the vehicle width direction Y.

The arcuate portion 49c is continuous with each of the rear ends of the pair of side portions 49a in the vehicle length direction X and has a semicircular arc shape protruding to the rear side in the vehicle length direction X. The arcuate portion 49c has a curvature along the inner wall of the second portion 24e2 of the guide concave portion 24e, and functions as a stopper that prevents further movement of the cam follower 49 in the direction W2 by abutting on the second portion 24e2.

The attachment portion 49d is provided at a top portion of the arcuate portion 49c on the rear side in the vehicle length direction X, and is attached to an end portion of the wire 47. In the first operating position shown in FIG. 12A, a part of the attachment portion 49d is located in the communication groove 24i of the base 20. In the second operating position shown in FIG. 9, the entire attachment portion 49d is located in the communication groove 24i of the base 20.

When the lid 25 in the closed state shown in FIG. 9 is operated to open and the cam 43 rotates in the direction R1, the press receiving portion 49b is pressed by the pressing portion 43f, and the cam follower 49 moves in the direction W1 from the second operation position toward the first operation position (see FIG. 12A). As a result, the wire 47 moves in conjunction, and the lock member 35 at the lock position moves to the unlock position (see FIG. 12B).

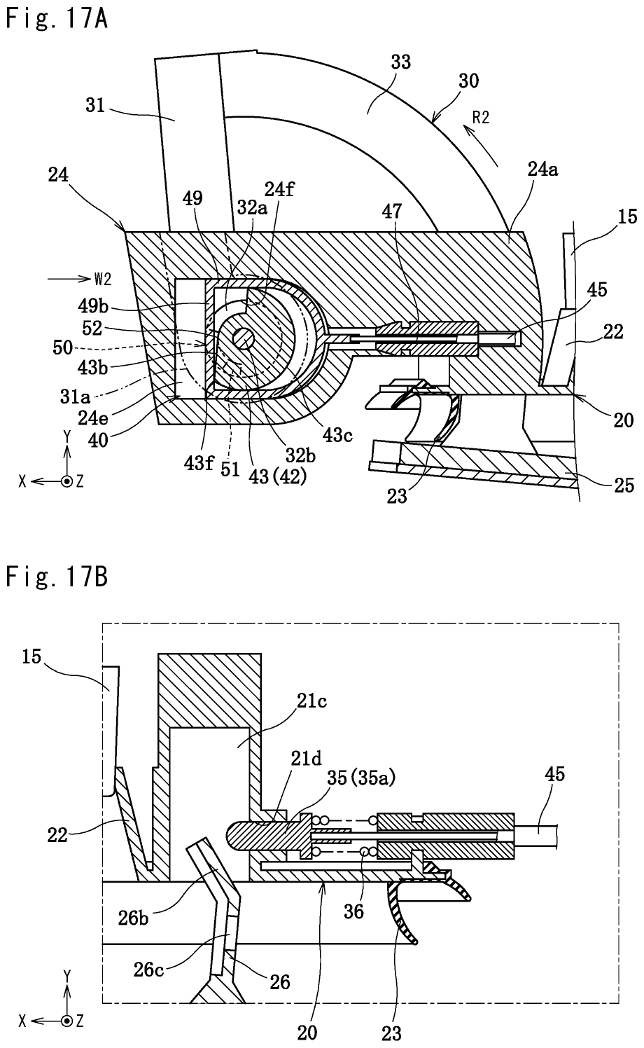

When the lid 25 in the open state shown in FIG. 14 is operated to close and the cam 43 rotates in the direction R2, the pressing portion 43f gradually moves to the rear side in the vehicle length direction X (see FIGS. 16 and 17A). As a result, since the holding position of the press receiving portion 49b by the pressing portion 43f is displaced, the lock member 35 biased by the spring 36 moves from the unlock position toward the lock position (see FIG. 17B), and the wire 47 also moves in conjunction therewith. As a result, the cam follower 49 gradually moves in the direction W2 from the first operation position toward the second operation position following the movement of the pressing portion 43f (see FIG. 17A).

Referring to FIGS. 7 and 8, the differential mechanism 50 is provided on the rotating body 42 and the pivot portion 31a of the arm 30, and starts the rotation of the pivot portion 31a with a delay after the rotation of the rotating body 42 starts. Specifically, the differential mechanism 50 includes a convex portion 51 provided on the rotating body 42 and a concave portion 52 provided on the shaft member 32 (pivot portion 31a). However, the convex portion 51 may be provided on the shaft member 32, and the concave portion 52 may be provided on the rotating body 42.

The convex portion 51 is provided to protrude from a lower surface of the cam 43 integrally molded with the rotating body 42. Referring to FIG. 10, the convex portion 51 has a fan shape when viewed from the vehicle height direction Z, and is provided at an interval radially outward with respect to the rotation axis A.

Referring to FIGS. 8 and 10, the concave portion 52 is provided in the flange portion 32a of the shaft member 32 included in the pivot portion 31a, and is formed of a notch recessed in the radial direction. The concave portion 52 has a fan shape larger than the convex portion 51 when viewed from the vehicle height direction Z, and the convex portion 51 is arranged inside.

An angular range r1 of the convex portion 51 around the rotation axis A is smaller than an angular range r2 of the concave portion 52 around the rotation axis A. As a result, a gap 53 of a difference between the angular ranges r1 and r2 is formed between the convex portion 51 and the concave portion 52 in the circumferential direction around the rotation axis A. The rotation of the rotating body 42 causes the opposing surfaces of the convex portion 51 and the concave portion 52 in the circumferential direction to abut and press, thereby rotating the pivot portion 31a. An angular range (r2-r1) of the gap 53 is a differential angular range α in which the shaft member 32 (pivot portion 31a) is rotated by being delayed after the rotation of the rotating body 42 is started.

Referring to FIG. 9, the differential angular range α is larger than the angular range β of the first straight portion 43b of the cam 43. As a result, after the lock member 35 at the lock position moves to the unlock position, the opposing surfaces of the convex portion 51 and the concave portion 52 abut on each other, and the rotational force of the rotating body 42 can be transmitted to the pivot portion 31a. A difference (α−β) between the differential angular range α and the angular range β is a delay angular range γ in which the rotation of the pivot portion 31a (arm 30) is started after the movement of the lock member 35 is completed.

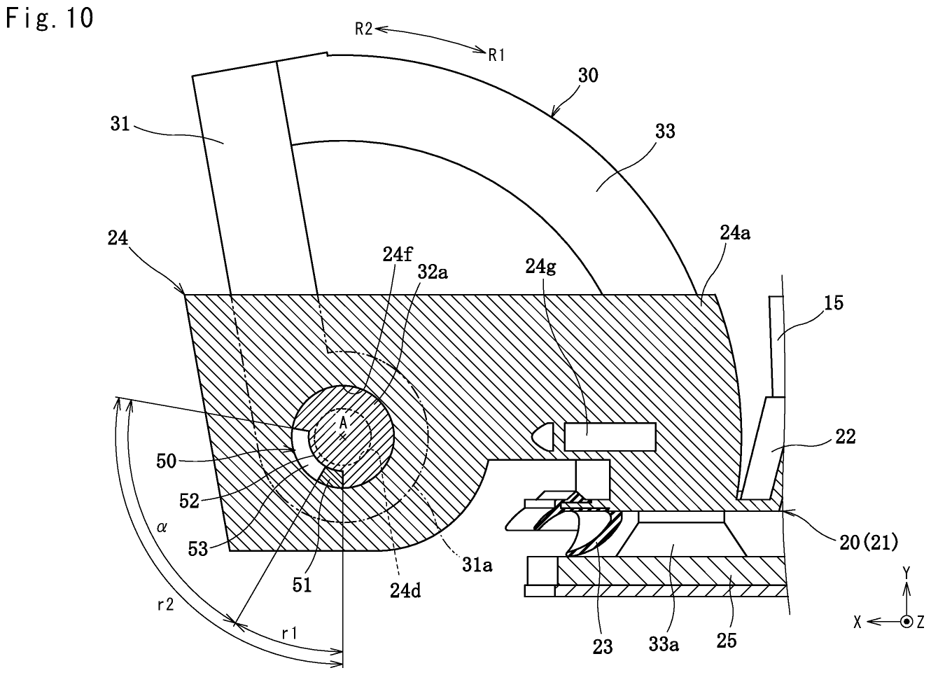

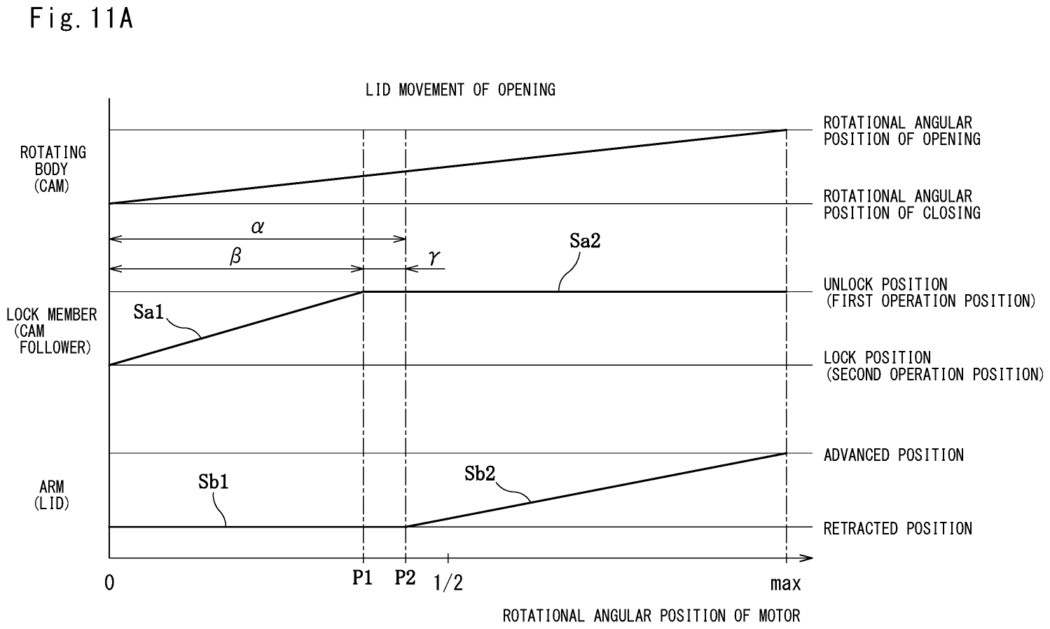

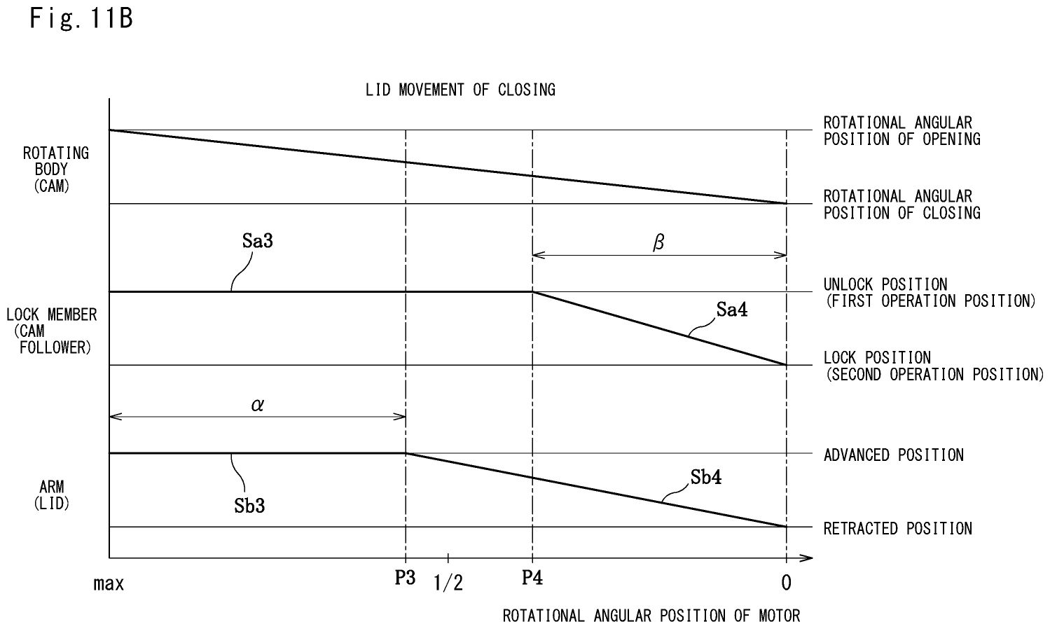

FIGS. 11A and 11B are graphs showing the movements of the arm 30 and the lock member 35 according to the rotational angular position of the motor 41 (rotating body 42). FIG. 11A shows a time of a lid opening operation of rotating the lid 25 at the closed position to the open position, and FIG. 11B shows a time of a lid closing operation of rotating the lid 25 at the open position to the closed position.

The angular ranges α, β, and γ shown in FIG. 9 are set so that the lid opening operation shown in FIG. 11A is established.

Specifically, referring to FIG. 11A, the motor 41 rotates forward from an initial rotational angular position (0) toward a maximum rotational angular position (max) during the opening operation of the lid 25. As a result, the rotating body 42 starts to rotate in the direction R1 from the closed rotational angular position toward the open rotational angular position. Since the cam 43 also starts to rotate in the direction R1 together with the rotating body 42, the cam follower 49 starts to move in the direction W1 from the second operation position to the first operation position shown in FIG. 9. As a result, since the wire 47 is pulled, the lock member 35 at the lock position starts to move to the unlock position as indicated by Sa1 in FIG. 11A. At this time, since the rotational force of the rotating body 42 is not transmitted to the pivot portion 31a due to the presence of the gap 53 of the differential mechanism 50, the arm 30 does not rotate as indicated by Sb1 in FIG. 11A. Note that the above-described closed rotational angular position means the posture of the rotating body 42 in a state where the arm 30 is moved to the retracted position as shown in FIG. 9, and the open rotational angular position means the posture of the rotating body 42 in a state where the arm 30 is moved to the advanced position as shown in FIG. 14.

Subsequently, when the motor 41 rotates beyond the angular position indicated by P1 in FIG. 11A, the rotating body 42 rotates from the closed rotational angular position by an angle corresponding to the angular range β of the first straight portion 43b of the cam 43 or more. As a result, the cam follower 49 moves from the second operation position to the first operation position, and shifts from a state of being pressed by the pressing portion 43f of the cam 43 to a state of being held by the first arcuate portion 43c. Therefore, the lock member 35 is held at the unlock position (see Sa2 in FIG. 11A).

Subsequently, when the motor 41 rotates beyond the angular position indicated by P2 in FIG. 11A, the rotating body 42 rotates from the closed rotational angular position by an angle corresponding to the differential angular range α or more. Therefore, the rotational force of the rotating body 42 is transmitted to the pivot portion 31a via the differential mechanism 50, and the arm 30 at the retracted position starts to move toward the advanced position (see Sb2 in FIG. 11A).

Thereafter, when the motor 41 rotates to the maximum rotational angular position (max), the rotating body 42 rotates to the open rotational angular position. As a result, the arm 30 rotates to the advanced position shown in FIG. 14, and the lid 25 opens the opening portion 3. Further, the lock member 35 continues to be held at the unlock position by the first arcuate portion 43c of the cam 43 (see FIG. 12B).

Referring to FIG. 11B, at the time of the closing operation of the lid 25, the motor 41 rotates backward from the maximum rotational angular position (max) toward the initial rotational angular position (0). As a result, the rotating body 42 starts to rotate in the direction R2 from the open rotational angular position toward the closed rotational angular position. The cam 43 also starts to rotate in the direction R2 integrally with the rotating body 42, but since the cam follower 49 is held by the first arcuate portion 43c of the cam 43, the lock member 35 is also held at the unlock position as indicated by Sa3 in FIG. 11B (see FIG. 16). In addition, since the rotational force is not transmitted to the pivot portion 31a due to the presence of the gap 53 of the differential mechanism 50, the arm 30 also does not rotate as indicated by Sb3 in FIG. 11B.

Subsequently, when the motor 41 rotates beyond the angular position indicated by P3 in FIG. 11B, the rotating body 42 rotates from the open rotational angular position by an angle corresponding to the differential angular range α or more. As a result, the rotational force of the rotating body 42 is transmitted to the pivot portion 31a, and the arm 30 at the advanced position starts to move toward the retracted position (see Sb4 in FIG. 11B). At this time, since the cam follower 49 is held by the first arcuate portion 43c of the cam 43, the lock member 35 is also held at the unlock position (see Sa3 in FIG. 11B).

Subsequently, when the motor 41 rotates beyond the angular position indicated by P4 in FIG. 11B, the cam follower 49 is shifted from the state of being held by the first arcuate portion 43c of the cam 43 to the state of being held by the first straight portion 43b. The position where the cam follower 49 is held by the first straight portion 43b is displaced rearward in the vehicle length direction X according to the rotation of the cam 43. Therefore, as indicated by Sa4 in FIG. 11B, the lock member 35 at the unlock position starts to move toward the lock position by the biasing force of the spring 36 (see FIG. 12B). As a result, the cam follower 49 also starts to move in the direction W2 from the first operating position toward the second operating position via the wire 47.

Thereafter, when the motor 41 rotates to the initial rotational angular position shown in FIG. 11B, the arm 30 moves to the retracted position via the differential mechanism 50 by the rotation of the rotating body 42, and the lid 25 closes the opening portion 3 (see FIG. 4). In addition, the lock member 35 moved to the lock position via the cam follower 49 and the wire 47 by the rotation of the cam 43 engages with the lock piece 26 of the lid 25 (see FIG. 6).

Here, the timing at which the lid 25 moves to the closed position and the timing at which the lock member 35 moves to the lock position may be the same or either may precede. When the timings are the same or the lid 25 precedes the lock member 35, the lock portion 35a enters and engages with the lock through hole 26c located on the front side in the moving direction of the lock member 35. When the lock member 35 precedes the lid 25, the inclined portion 26b of the lock piece 26 presses the lock portion 35a at the lock position to retract the lock member 35 to the unlock position side, and after the movement of the lid 25 is completed, the lock member 35 is moved to the lock position by the biasing force of the spring 36, and the lock portion 35a can engage with the lock through hole 26c.

As described above, by setting the angular ranges α, β, and γ so that the lid opening operation shown in FIG. 11A is established, the locking and unlocking of the lid 25 by the lock member 35 can be realized without hindering the movement of the arm 30 between the advanced position shown in FIG. 3 and the retracted position shown in FIG. 4 by one motor 41.

Next, the operation of the lid opening and closing device 10 configured as described above will be described.

First, as shown in FIGS. 9 and 10, in a state where the arm 30 is rotated to the retracted position and the lid 25 is rotated to the closed position, the lock member 35 engage with the lock through hole 26c of the lid 25 as shown in FIG. 6. Referring to FIG. 9, the first straight portion 43b of the cam 43 is in surface contact with the press receiving portion 49b of the cam follower 49, and referring to FIG. 10, the convex portion 51 of the differential mechanism 50 is located at the end portion on the direction R2 side in the concave portion 52.

In this closed state, when any one of a switch (not shown) attached to the base 20, an opening switch (not shown) provided in the vehicle, and an opening switch (not shown) of an electronic key is operated, the motor 41 rotates forward. Accordingly, the rotating body 42 and the cam 43 start to rotate in the direction R1, and the cam follower 49 and the wire 47 start to move in the direction W1. As a result, the lock member 35 at the lock position starts to move toward the unlock position.

However, until the rotating body 42 rotates by the angle corresponding to the differential angular range α of the differential mechanism 50, as shown in FIG. 12A, the convex portion 51 moves only in the gap 53 and does not press the opposing surface of the concave portion 52, and thus the pivot portion 31a of the arm 30 does not rotate. During this time, the cam follower 49 moves from the second operation position to the first operation position by the rotation of the cam 43. As a result, the lock member 35 is pulled via the wire 47, and the lock member 35 at the lock position moves to the unlock position as shown in FIG. 12B.

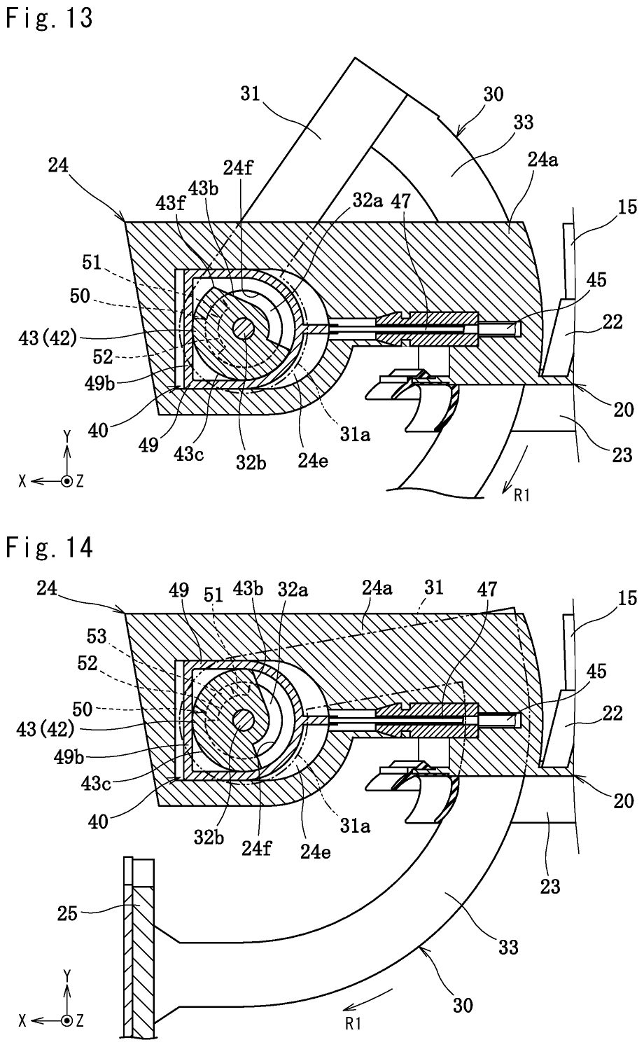

Subsequently, by the rotation of the rotating body 42, the convex portion 51 abuts on the opposing surface of the concave portion 52 and is pressed toward the direction R1 side. As a result, as shown in FIG. 13, the arm 30 at the retracted position starts to move toward the advanced position, and the lid 25 at the closed position starts to move toward the open position. At this time, since the cam follower 49 is held at the first operation position by the first arcuate portion 43c of the cam 43, the lock member 35 is held at the unlock position via the wire 47, and does not hinder the rotation of the lid 25.

Thereafter, as shown in FIGS. 3 and 14, when the arm 30 moves to the advanced position, the lid 25 moves to the open position, and opens the opening portion 3 to expose the power supply connector 15 to the outside. During this time, the cam follower 49 is held at the first operation position by the first arcuate portion 43c of the cam 43, and the lock member 35 is held at the unlock position via the wire 47.

When any one of a switch (not shown) attached to the base 20, a closing switch (not shown) provided in the vehicle, and a closing switch (not shown) of the electronic key is operated in the open state shown in FIG. 14, the motor 41 rotates backward. As a result, the rotating body 42 and the cam 43 start to rotate in the direction R2.

However, until the rotating body 42 rotates by the angle corresponding to the differential angular range α of the differential mechanism 50, as shown in FIG. 15, the convex portion 51 moves only in the gap 53 and does not press the opposing surface of the concave portion 52, and thus the pivot portion 31a of the arm 30 does not rotate. In addition, since the cam follower 49 is held at the first operation position by the first arcuate portion 43c of the cam 43, the lock member 35 is also held at the unlock position via the wire 47.

Subsequently, by the rotation of the rotating body 42, the convex portion 51 abuts on the opposing surface of the concave portion 52 and is pressed toward the direction R2 side. As a result, as shown in FIG. 16, the arm 30 at the advanced position starts to move toward the retracted position, and the lid 25 at the open position starts to move toward the closed position. Thereafter, the cam follower 49 is shifted from the state of being held by the first arcuate portion 43c of the cam 43 to the state of being held by the first straight portion 43b. Referring to FIGS. 16 and 17A, the holding position of the cam follower 49 by the first straight portion 43b is displaced from the front side to the rear side in the vehicle length direction X according to the rotation of the cam 43. Due to the displacement of the holding position, the lock member 35 at the unlock position starts to move toward the lock position by the biasing force of the spring 36, and the cam follower 49 at the first operation position starts to move toward the second operation position via the wire 47.

Thereafter, as shown in FIGS. 17A and 17B, when the arm 30 rotates to the vicinity of the retracted position by the rotation of the rotating body 42 and the lid 25 moves to the rotational angular position where the lid 25 abuts on the seal member 23, the distal end of the lock piece 26 of the lid 25 enters the concave portion 21c of the base 20. As shown in FIGS. 4 and 9, when the arm 30 rotates to the retracted position by the rotation of the rotating body 42, the lid 25 closes the opening portion 3 of the side panel 1 and covers the power supply connector 15. As shown in FIG. 6, the lock member 35 moved to the lock position engages with the lock piece 26 that has entered the concave portion 21c. Thus, the closed state of the lid 25 can be maintained.

The lid opening and closing device 10 configured as described above has the following features.

Since the rotating body 42 that transmits the drive force of the motor 41 to the pivot portion 31a of the arm 30 to rotate is provided, the lid 25 can be automatically opened and closed via the arm 30. Furthermore, the cam 43 that rotates in conjunction with the rotating body 42, the cable 45 (wire 47) movable by the cam 43, and the lock member 35 attached to the cable 45 are provided, and the lock member 35 engages with the lock piece 26 of the lid 25 when the arm 30 rotates to the retracted position, so that the lid 25 can be locked in an unreleasable manner. As described above, since the automatic opening and closing and the locking of the lid 25 can be realized by one motor 41, security can be improved while suppressing an increase in size and cost of the lid opening and closing device 10 as compared with the case of mounting two motors 41.

When the lock member 35 at the lock position is moved to the unlock position by the movement of the cable 45 (wire 47), the differential mechanism 50 starts the rotation of the pivot portion 31a. Specifically, the differential mechanism 50 has the convex portion 51 provided on one of the pivot portion 31a and the rotating body 42 and the concave portion 52 provided on the other, and has the gap 53 of the determined differential angular range α between the convex portion 51 and the concave portion 52 in the circumferential direction. Therefore, the automatic opening and closing and the locking of the lid 25 can be realized by one motor 41 without hindering the opening and closing of the lid 25 by the lock member 35.

Since the cable 45 is used, even when the rotating body 42 and the cam 43 are arranged on the bearing portion 24 side of the base 20, the lock member 35 can be arranged on the side of the base 20 opposite to the bearing portion 24. That is, the distal end side of the lid 25, which is the side opposite to the pivot portion 31a of the arm 30 (lid 25), can be locked by the lock member 35. Therefore, as compared with the case where the vicinity of the bearing portion 24 (for example, the arm 30) is locked by the lock member 35, the load applied to the lock member 35 when the lid 25 in the closed state is illegally operated can be reduced, and the lid 25 can be reliably positioned at the opening portion 3.

Since the cam follower 49 has an annular shape surrounding the non-circular outer peripheral portion 43a of the cam 43, it can reliably receive the pressing force of the cam 43 and reliably move the lock member 35 via the cable 45.

Since the cable 45 including the tube 46 and the wire 47 is used as the transmission member, the arrangement of the lock member 35 with respect to the lid 25 can be freely set according to the layout of the automobile and the like.

Since the spring 36 that biases the lock member 35 is attached between the tube 46 and the lock member 35, the lock member 35 at the unlock position can be reliably moved to the lock position with a simple structure. In addition, as compared with the case where the spring 36 is arranged between the base 20 (for example, the attachment piece 21f shown in FIG. 5) and the lock member 35, the arrangement structure of the spring 36 can be simplified, and the degree of freedom in the layout of the entire lid opening and closing device 10 can be improved.

Since the rotating body 42 is arranged coaxially with the pivot portion 31a, the entire lid opening and closing device 10 can be downsized.

Since the cam 43 has an integral structure with the rotating body 42 and is arranged between the rotating body 42 and the pivot portion 31a, it is possible to reduce the size of the coupling portion (differential mechanism 50) between the rotating body 42 and the pivot portion 31a and to improve the transmission of the drive force.

Note that the present invention is not limited to the configuration of the above embodiment, and various modifications can be made.

For example, the lid 25 (arm 30) may be rotatable in the vertical direction about a rotation axis extending in the vehicle length direction X.

The differential mechanism 50 can be changed as necessary as long as it has a configuration (structure) capable of starting the rotation of the pivot portion 31a (arm 30) after moving the lock member 35 at the lock position to the unlock position.

The rotating body 42 and the cam 43 may be formed separately, and the cam 43 may rotate in conjunction with the rotating body 42 via a transmission member such as a gear.

The transmission member movable by the cam 43 may be a rod. In this case, the lock member 35 is arranged on the left side of the concave portion 21c of the base 20 shown in FIG. 2. Alternatively, the right side in FIG. 9 is set as the first operation position, the left side is set as the second operation position, and the direction in which the cam follower 49 is moved by the cam 43 is the left-right opposite direction in FIG. 9.

As long as the cam follower 49 can follow the rotation of the cam 43, the cam follower 49 may have a shape other than the semi-elliptical shape or a shape other than the annular shape, and can be changed as necessary.

### REFERENCE SIGNS LIST

1 side panel (panel)
2 concave portion
3 opening portion
4 attachment port
10 lid opening and closing device
15 power supply connector (receiving portion)
15a connecting portion.
20 base
21 base body
21a insertion through hole
21b window through hole
21c concave portion
21d insertion through hole
21e holding portion
21f attachment piece
22 attachment portion
22a concave portion
22b attachment port
23 seal member
24 bearing portion
24a end plate
24b coupling plate
24c shaft hole
24d shaft through hole
24e guide concave portion
24e1 first portion
24e2 second portion
24f holding concave portion
24g attachment concave portion
24h holding piece
24i communication groove
25 lid
26 lock piece (engaging portion)
26a lock piece body
26b inclined portion
26c lock through hole
27 pressing portion
30 arm
31 first arm portion
31a pivot portion
31b attachment through hole
32 shaft member
32a flange portion
32b shaft portion
33 second arm portion
33a connecting portion (distal end portion)
35 lock member
35a lock portion
35b flange portion
35c attachment portion
36 spring (biasing member)
40 drive mechanism
41 motor (drive source)
42 rotating body
42a attachment portion
43 cam
43a outer peripheral portion
43b first straight portion
43c first arcuate portion
43d second arcuate portion
43e second straight portion
43f pressing portion
45 cable
46 tube
47 wire (transmission member).
48A, 48B cable end.
49 cam follower
49a side portion
49b press receiving portion
49c arcuate portion
49d attachment portion
50 differential mechanism
51 convex portion
52 concave portion
53 gap

1. A lid opening and closing device comprising:
a base including a bearing portion and arranged inside an opening portion of a panel;
a receiving portion attached to the base so as to be located in the opening portion;
a lid that openably closes the opening portion;
an arm including a pivot portion on one end side pivotally supported by the bearing portion and a distal end portion on the other end side connected to the lid, the arm being movable between a retracted position where the arm is retracted into the panel and the opening portion is closed by the lid, and an advanced position where the arm is protruded to an outside of the panel and the opening portion is opened;
a rotating body that transmits a drive force received from a drive source to the pivot portion to move the arm between the retracted position and the advanced position;
a cam that rotates in conjunction with the rotating body;
a transmission member movable by the cam;
a lock member that is attached to the transmission member moves between a lock position and an unlock position by transmitting a rotational force of the rotating body via the cam and the transmission member;
an engaging portion provided on the lid, the engaging portion being engageable with the lock member having moved to the lock position when the arm is at the retracted position; and
a differential mechanism that starts rotation of the pivot portion with a delay with respect to start of rotation of the rotating body when the arm at the retracted position is moved to the advanced position.

2. The lid opening and closing device according to claim 1, wherein, when the lock member at the lock position is moved to the unlock position by rotation of the rotating body, the differential mechanism starts rotation of the pivot portion.

3. The lid opening and closing device according to claim 1,
wherein rotation axes of the pivot portion and the rotating body coincide with each other,
wherein the differential mechanism includes:
a convex portion provided on one of the pivot portion and the rotating body; and
a concave portion provided in the other one of the pivot portion and the rotating body and having the convex portion arranged therein,
wherein an angular range of the convex portion around a rotation axis is smaller than an angular range of the concave portion around the rotation axis,
wherein a gap of a predetermined differential angular range is provided between the convex portion and the concave portion in a circumferential direction around the rotation axis, and
wherein rotation of the rotating body causes opposing surfaces of the convex portion and the concave portion in the circumferential direction to abut and press, thereby rotating the pivot portion.

4. The lid opening and closing device according to claim 1,
wherein the rotating body and the cam are arranged on the bearing portion side of the base,
wherein the transmission member includes a cam follower that follows rotation of the cam at an end portion on the bearing portion side, and
wherein the lock member is attached to an end portion of the transmission member, the end portion being arranged on a side opposite to the bearing portion of the base.

5. The lid opening and closing device according to claim 4,
wherein the cam has an outer peripheral portion having a non-circular shape, and
wherein the cam follower has an annular shape surrounding the outer peripheral portion.

6. The lid opening and closing device according to claim 4,
wherein the transmission member is a cable including a tube having flexibility and a wire movable forward and backward in the tube, and
wherein the lock member and the cam follower are attached to the wire.

7. The lid opening and closing device according to claim 6, wherein a biasing member that biases the lock member at the unlock position toward the lock position is attached between the tube and the lock member.

8. The lid opening and closing device according to claim 1, wherein the rotating body is arranged coaxially with the pivot portion.

9. The lid opening and closing device according to claim 8, wherein the cam has an integral structure with the rotating body, and is arranged so as to be adjacent to the pivot portion.

10. The lid opening and closing device according to claim 2,
wherein rotation axes of the pivot portion and the rotating body coincide with each other,
wherein the differential mechanism includes:
a convex portion provided on one of the pivot portion and the rotating body; and
a concave portion provided in the other one of the pivot portion and the rotating body and having the convex portion arranged therein,
wherein an angular range of the convex portion around a rotation axis is smaller than an angular range of the concave portion around the rotation axis,
wherein a gap of a predetermined differential angular range is provided between the convex portion and the concave portion in a circumferential direction around the rotation axis, and
wherein rotation of the rotating body causes opposing surfaces of the convex portion and the concave portion in the circumferential direction to abut and press, thereby rotating the pivot portion.

11. The lid opening and closing device according to claim 2,
wherein the rotating body and the cam are arranged on the bearing portion side of the base,
wherein the transmission member includes a cam follower that follows rotation of the cam at an end portion on the bearing portion side, and
wherein the lock member is attached to an end portion of the transmission member, the end portion being arranged on a side opposite to the bearing portion of the base.

12. The lid opening and closing device according to claim 3,
wherein the rotating body and the cam are arranged on the bearing portion side of the base,
wherein the transmission member includes a cam follower that follows rotation of the cam at an end portion on the bearing portion side, and
wherein the lock member is attached to an end portion of the transmission member, the end portion being arranged on a side opposite to the bearing portion of the base.

13. The lid opening and closing device according to claim 10,
wherein the rotating body and the cam are arranged on the bearing portion side of the base,
wherein the transmission member includes a cam follower that follows rotation of the cam at an end portion on the bearing portion side, and
wherein the lock member is attached to an end portion of the transmission member, the end portion being arranged on a side opposite to the bearing portion of the base.

14. The lid opening and closing device according to claim 11,
wherein the cam has an outer peripheral portion having a non-circular shape, and
wherein the cam follower has an annular shape surrounding the outer peripheral portion.

15. The lid opening and closing device according to claim 12,
wherein the cam has an outer peripheral portion having a non-circular shape, and
wherein the cam follower has an annular shape surrounding the outer peripheral portion.

16. The lid opening and closing device according to claim 13,
wherein the cam has an outer peripheral portion having a non-circular shape, and
wherein the cam follower has an annular shape surrounding the outer peripheral portion.

17. The lid opening and closing device according to claim 5,
wherein the transmission member is a cable including a tube having flexibility and a wire movable forward and backward in the tube, and
wherein the lock member and the cam follower are attached to the wire.

18. The lid opening and closing device according to claim 14,
wherein the transmission member is a cable including a tube having flexibility and a wire movable forward and backward in the tube, and
wherein the lock member and the cam follower are attached to the wire.

19. The lid opening and closing device according to claim 15,
wherein the transmission member is a cable including a tube having flexibility and a wire movable forward and backward in the tube, and
wherein the lock member and the cam follower are attached to the wire.

20. The lid opening and closing device according to claim 16,
wherein the transmission member is a cable including a tube having flexibility and a wire movable forward and backward in the tube, and
wherein the lock member and the cam follower are attached to the wire.
